(19) United States
(12) Patent Application Publication
(10) Pub. No.: US 2025/0193345 A1
(43) Pub. Date: Jun. 12, 2025

(54) METHOD AND SYSTEM FOR CHECK-IN USING A CAMERA ASSIGNED FROM AMONGST A PLURALITY OF PRE-DEPLOYED CAMERAS

(71) Applicant: MOTOROLA SOLUTIONS, INC., Chicago, IL (US)

(72) Inventors: DANIELA STANKOVSKA, FORT LAUDERDALE, FL (US); MATTHEW WANNER, PLANTATION, FL (US); MARK C. TARABOULOS, SUWANEE, GA (US); KEVIN K. MAGGERT, DACULA, GA (US)

(21) Appl. No.: 18/537,283

(22) Filed: Dec. 12, 2023

(51) Int. Cl. H04N 7/18; G06Q 50/26; G06V 20/52; G08B 13/196

(52) U.S. Cl. CPC H04N 7/181; G06Q 50/265; G06V 20/52; G08B 13/19656

(57) ABSTRACT

A method and system for check-in using a camera assigned from amongst a plurality of pre-deployed cameras is disclosed. The method includes identifying the plurality of pre-deployed security cameras within a geographic region that are potentially accessible to a person for a virtual appearance relating to individualized conditions imposed on the person under at least one legally enforceable order. The method also includes assigning one camera from the plurality of pre-deployed security cameras for access by the person during a defined time period which will begin at a point in time after the assigning of the camera.

### BACKGROUND

In a post Covid-19 world, people are increasingly making virtual appearances (e.g. appearing in front of a video camera and a microphone) instead of in-person appearances. Virtual appearances can have advantages over in-person appearances. For instance, virtual appearances can save time and money, since usually the distance for a person to travel to appear in front of a video camera is much less than the distance that person needs to travel to make an in-person appearance. Also, virtual meetings may promote inclusivity by breaking down barriers to physical accessibility (i.e. participants with disabilities or limited mobility can sometimes more easily attend virtual meetings than in-person meetings). Also, virtual appearances can facilitate an augmented experience through video and/or audio analytics, or other intelligent functionality incorporated into the system that supports the virtual appearance.

### BRIEF DESCRIPTION OF THE SEVERAL VIEWS OF THE DRAWINGS

In the accompanying figures similar or the same reference numerals may be repeated to indicate corresponding or analogous elements. These figures, together with the detailed description, below are incorporated in and form part of the specification and serve to further illustrate various embodiments of concepts that include the claimed invention, and to explain various principles and advantages of those embodiments.

FIG. 1 is a block diagram of a multisite system in accordance with example embodiments.

FIG. 2 is a flow chart illustrating a computer-implemented method in accordance with an example embodiment.

FIG. 3 is a diagram illustrating a geographic region, and within which are depicted locations of a plurality of pre-deployed cameras.

FIG. 4 is a diagram illustrating a virtual appearance consistent with the example embodiment of FIG. 2.

Skilled artisans will appreciate that elements in the figures are illustrated for simplicity and clarity and have not necessarily been drawn to scale. For example, the dimensions of some of the elements in the figures may be exaggerated relative to other elements to help improve understanding of embodiments of the present disclosure.

The system, apparatus, and method components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

### DETAILED DESCRIPTION OF THE INVENTION

In accordance with one example embodiment, there is provided a computer-implemented method that includes generating, using an at least one processor, a user profile for a person. The user profile is based on predetermined parameters corresponding to individualized conditions imposed on the person under at least one legally enforceable order. The computer-implemented method also includes identifying, using the at least one processor, a plurality of pre-deployed security cameras within a geographic region that are potentially accessible to the person for a virtual appearance relating to the individualized conditions. The computer-implemented method also includes assigning, using the at least one processor, one camera from the plurality of pre-deployed security cameras for access by the person during a defined time period which will begin at a point in time after the assigning of the camera. The computer-implemented method also includes analyzing, using the at least one processor, user provided input received, during the defined time period, at the assigned camera. The person is providing the user provided input as an at least one verification of compliance condition imposed under the at least one legally enforceable order.

In accordance with another example embodiment, there is provided a system that includes an at least one processor and an at least one electronic storage medium in communication with the at least one processor. The at least one electronic storage medium stores program instructions that when executed by the at least one processor cause the at least one processor to perform generating a user profile for a person. The user profile is based on predetermined parameters corresponding to individualized conditions imposed on the person under at least one legally enforceable order. The at least one processor is also caused to perform identifying a plurality of pre-deployed security cameras within a geographic region that are potentially accessible to the person for a virtual appearance relating to the individualized conditions. The at least one processor is also caused to perform assigning one camera from the plurality of pre-deployed security cameras for access by the person during a defined time period which will begin at a point in time after the assigning of the camera. The at least one processor is also caused to perform analyzing user provided input received, during the defined time period, at the assigned camera. The person is providing the user provided input as an at least one verification of compliance condition imposed under the at least one legally enforceable order.

Each of the above-mentioned embodiments will be discussed in more detail below, starting with example system and device architectures of the system in which the embodiments may be practiced, followed by an illustration of processing blocks for achieving an improved technical method, device, and system for check-in using a camera assigned from amongst a plurality of pre-deployed cameras.

Example embodiments are herein described with reference to flowchart illustrations and/or block diagrams of methods, apparatus (systems) and computer program products according to example embodiments. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a special purpose and unique machine, such that the instructions, which execute via the processor of the computer or other programmable data processing apparatus, create means for implementing the functions/acts specified in the flowchart and/or block diagram block or blocks. The methods and processes set forth herein need not, in some embodiments, be performed in the exact sequence as shown and likewise various blocks may be performed in parallel rather than in sequence. Accordingly, the elements of methods and processes are referred to herein as “blocks” rather than “steps.”

These computer program instructions may also be stored in a computer-readable memory that can direct a computer or other programmable data processing apparatus to function in a particular manner, such that the instructions stored in the computer-readable memory produce an article of manufacture including instructions which implement the function/act specified in the flowchart and/or block diagram block or blocks.

The computer program instructions may also be loaded onto a computer or other programmable data processing apparatus that may be on or off-premises, or may be accessed via the cloud in any of a software as a service (Saas), platform as a service (PaaS), or infrastructure as a service (IaaS) architecture so as to cause a series of operational blocks to be performed on the computer or other programmable apparatus to produce a computer implemented process such that the instructions which execute on the computer or other programmable apparatus provide blocks for implementing the functions/acts specified in the flowchart and/or block diagram block or blocks. It is contemplated that any part of any aspect or embodiment discussed in this specification can be implemented or combined with any part of any other aspect or embodiment discussed in this specification.

Further advantages and features consistent with this disclosure will be set forth in the following detailed description, with reference to the figures.

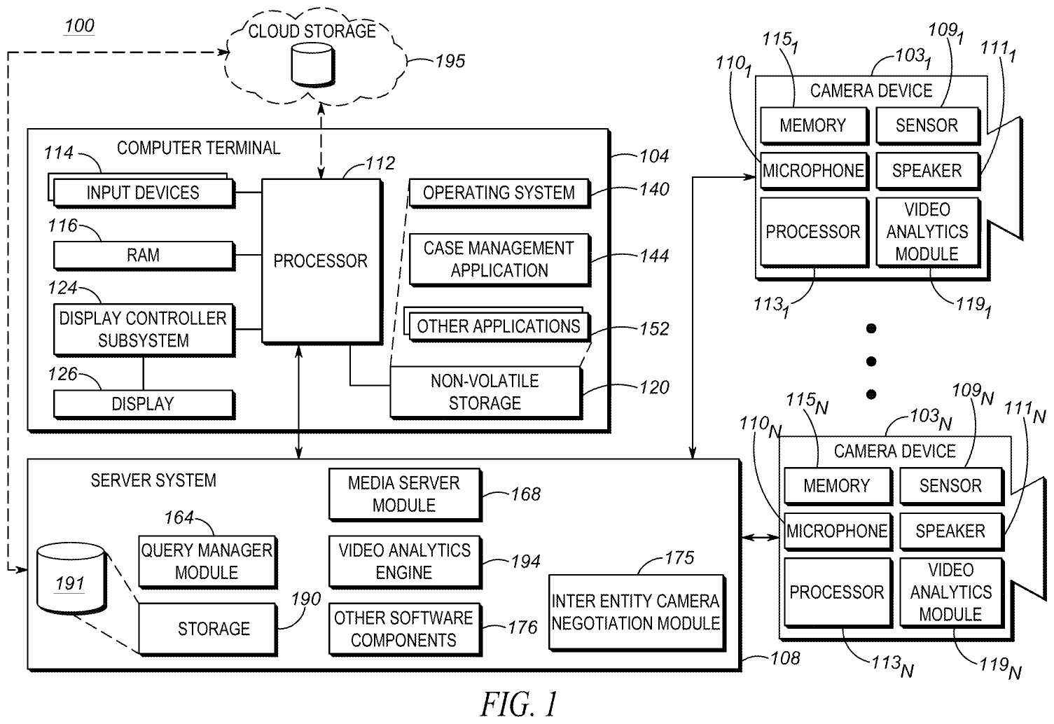

Referring now to the drawings, and in particular FIG. 1 which is a block diagram of an example multisite system 100 within which methods in accordance with example embodiments can be carried out. Included within the illustrated multisite system 100 are one or more computer terminals 104 and a server system 108. In some example embodiments, the computer terminal 104 is a personal computer system (such as, for instance, a desktop computer); however in other example embodiments the computer terminal 104 is a mobile device such as, for example, a tablet, a phablet, a two-way radio, a smart phone or a personal digital assistant (PDA); a laptop computer; a desktop computer; a smart television; and other suitable devices. With respect to the server system 108, this could comprise a single physical machine or multiple physical machines. It will be understood that the server system 108 need not be contained within a single chassis, nor necessarily will there be a single location for the server system 108.

As will be appreciated by those skilled in the art, at least some of the functionality of the server system 108 can be implemented within the computer terminal 104 rather than within the server system 108. While just one computer terminal is shown in FIG. 1, this is for convenience of illustration (any suitable number of computer terminals 104 are contemplated). In at least one example, the primary user of the computer terminal is someone employed to ensure that various people (who are assigned as case files to that person) are following terms of some legally enforceable order.

The computer terminal 104 communicates with the server system 108 through one or more networks. These networks can include the Internet, or one or more other public/private networks coupled together by network switches or other communication elements. As an example and not by way of limitation, the computer terminal 104 can communicate with an ad-hoc network, a Personal Area Network (PAN), a Local Area Network (LAN), a Wide Area Network (WAN), a Metropolitan Area Network (MAN), or one or more portions of the Internet or a combination of two or more of these. One or more portions of one or more of these networks may be wireless. As an example, the computer terminal 104 may be capable of communicating with a Wireless PAN (WPAN) (such as, for example, a BLUETOOTH WPAN), a WI-FI network, a WI-MAX network, an LTE network, an LTE-A network, a cellular telephone network (such as, for example, a Global System for Mobile Communications (GSM) network), or any other suitable wireless network or a combination of two or more of these.

The computer terminal 104 includes at least one processor 112 that controls the overall operation of the computer terminal. The processor 112 interacts with various subsystems such as, for example, input devices 114 (such as a selected one or more of a keyboard, mouse, scanner, touch pad, roller ball and microphone/voice control means, for example), random access memory (RAM) 116, non-volatile storage 120, display controller subsystem 124 and other subsystems. The display controller subsystem 124 interacts with display screen 126 and it renders graphics and/or text upon the display screen 126.

Still with reference to the computer terminal 104 of the multisite system 100, operating system 140 and various software applications used by the processor 112 are stored in the non-volatile storage 120. The non-volatile storage 120 is, for example, one or more hard disks, solid state drives, or some other suitable form of computer readable medium that retains recorded information after the computer terminal 104 is turned off. Regarding the operating system 140, this includes software that manages computer hardware and software resources of the computer terminal 104 and provides common services for computer programs. Also, those skilled in the art will appreciate that the operating system 140, case management application 144, and other applications 152, or parts thereof, may be temporarily loaded into a volatile store such as the RAM 116. The processor 112, in addition to its operating system functions, can enable execution of the various software applications on the computer terminal 104.

Regarding the case management application 144, this is an application to manage case files of people who need to be monitored and/or assisted in some manner to ensure that they are complying with terms of some legally enforceable order. In at least one example, the case management application 144 includes specific functionality allowing a parole or probation officer to manage case files of parolees or probationers.

Still with reference to FIG. 1, the server system 108 includes several software components for carrying out other functions of the server system 108. For example, the server system 108 includes a media server module 168. The media server module 168 handles client requests related to storage and retrieval of video taken by camera devices 103₁-103_{N} in the multisite system 100. The server system 108 also includes a video analytics engine 194. The video analytics engine 194 can, in some examples, be any suitable one of known commercially available software that carry out computer vision related functions (complementary to any video analytics performed in the security cameras) as understood by a person of skill in the art. Other suitable implementation alternatives, apparent to those skilled in the art, are also contemplated. In at least some examples, the video analytics engine 194 includes learning machine(s) in support of the operation of the video analytics engine 194.

The server system 108 also includes an inter entity camera negotiation module 175. The inter entity camera negotiation module 175 facilitates the shared use of camera resources which are not primarily operated by a same entity that operates the server system 108. The server system 108 also includes a number of other software components 176. These other software components will vary depending on the requirements of the server system 108 within the overall system. As one example, the other software components 176 might include special test and debugging software, or software to facilitate version updating of modules within the server system 108.

Regarding the data store 190, this comprises, for example, one or more databases 191 which may facilitate the organized storing of recorded video captured by camera devices, other sensor data, etc. in accordance with example embodiments. The one or more databases 191 may also contain metadata related to, for example, the recorded video that is storable within the one or more data stores 190. Examples of metadata that may be expected to be derived directly or indirectly from video data include location in field of view, object ID, bounding box-related data, tracking position relative to field of view, etc. The one or more databases 191 may also contain records and data concerning people that are under respective legally enforceable order(s), and these records and data may be retrievable through queries made via a query manager module 164 with respect to which the case management application 144 operably interfaces.

Optionally, the multisite system 100 may include connections to the illustrated one or more cloud services 195. For example, the computer terminal 104 may be connected to the cloud service(s) 195 by the Internet and/or one or more wireless and/or wired wide area networks (examples of which were previously herein detailed). Similarly, the server system 108 may be connected to the cloud service(s) 195 by the Internet and/or one or more wireless and/or wired wide area networks (examples of which were previously herein detailed). The cloud service(s) 195 which may, amongst other things, include neural network(s), and may also include functionality similar and/or complementary to functionality provided by the server system 108.

The illustrated multisite system 100 also includes a plurality of camera devices 103₁-103_{N} (hereinafter interchangeably referred to as “cameras 103₁-103_{N}” when referring to all of the illustrated cameras, or “camera 103” when referring to any individual one of the plurality) being operable to capture a plurality of images and produce image data representing the plurality of captured images. The camera 103 is an image capturing device and includes security video cameras. Furthermore, it will be understood that the multisite system 100 includes any suitable number of cameras (i.e. n is any suitable integer greater than one).

In some examples, some or all of the cameras 103₁-103_{N} are geographically located within different premises serviced by the multisite system 100. (Non-limiting examples of possible premises are later herein described.)

The camera 103 includes an image sensor 109 (corresponding to one of the sensors 109₁-109_{N} shown in FIG. 1) for capturing a plurality of images. The camera 103 may be a digital video camera and the image sensor 109 may output captured light as a digital data. For example, the image sensor 109 may be a CMOS, NMOS, or CCD. In some embodiments, the camera 103 may be an analog camera connected to an encoder. The illustrated camera 103 may be a 2D camera; however use of a structured light 3D camera, a time-of-flight 3D camera, a 3D Light Detection and Ranging (LiDAR) device, a stereo camera, or any other suitable type of camera within the multisite system 100 is contemplated.

The camera 103 may be a dedicated camera. It will be understood that a dedicated camera herein refers to a camera whose principal features is to capture images or video. In some example embodiments, the dedicated camera may perform functions associated with the captured images or video, such as but not limited to processing the image data produced by it or by another camera. For example, the dedicated camera may be a security camera, such as any one of a Pan-Tilt-Zoom (PTZ) camera, dome camera, in-ceiling camera, box camera, and bullet camera.

Additionally, or alternatively, the camera 103 may include an embedded camera. It will be understood that an embedded camera herein refers to a camera that is embedded within a device that is operational to perform functions that are unrelated to the captured image or video. For example, the embedded camera may be a camera found on any one of a vehicle, a security panel, doorbell device, etc.

The camera 103 includes one or more optional microphones 110 (corresponding to one of the microphones 110₁-110_{N} shown in FIG. 1), one or more optional speakers 111 (corresponding to one of the speakers 111₁-111_{N} shown in FIG. 1), one or more processors 113 (corresponding to one of the processors 113₁-113_{N} shown in FIG. 1), one or more video analytics modules 119 (corresponding to one of the video analytics modules 119₁-119_{N} shown in FIG. 1), and one or more memory devices 115 (corresponding to one of the memories 115₁-115_{N} shown in FIG. 1) coupled to the processors and one or more network interfaces. Regarding the video analytics module 119, this generates metadata outputted to the server system 108. The metadata can include, for example, records which describe various detections of objects such as, for instance, pixel locations for the detected object in respect of a first record and a last record for the camera within which the respective metadata is being generated. In at least some examples, the video analytics module 119 includes learning machine(s) in support of the operation of the video analytics module 119.

As an alternative to the camera 103 including both the microphone 110 and the speaker 111, the camera 103 may include none or only one of the microphone 110 and the speaker 111. For instance, it is a contemplated alternative that a person needing to use the camera 103 for a virtual appearance may carry a kit that includes at least one of a microphone and a portable speaker that connects (e.g. wirelessly or via a cable) to the camera 103.

Regarding the memory device 115, this can include a local memory (such as, for example, a RAM and a cache memory) employed during execution of program instructions. Regarding the processor 113, this executes computer program instructions (such as, for example, an operating system and/or software programs), which can be stored in the memory device 115.

In various embodiments the processor 113 may be implemented by any suitable processing circuit having one or more circuit units, including a digital signal processor (DSP), graphics processing unit (GPU) embedded processor, a visual processing unit or a vison processing unit (both referred to herein as “VPU”), etc., and any suitable combination thereof operating independently or in parallel, including possibly operating redundantly. Such processing circuit may be implemented by one or more integrated circuits (IC), including being implemented by a monolithic integrated circuit (MIC), an Application Specific Integrated Circuit (ASIC), a Field Programmable Gate Array (FPGA), etc. or any suitable combination thereof. Additionally or alternatively, such processing circuit may be implemented as a programmable logic controller (PLC), for example. The processor may include circuitry for storing memory, such as digital data, and may comprise the memory circuit or be in wired communication with the memory circuit, for example. A system on a chip (SOC) implementation is also common, where a plurality of the components of the camera 103, including the processor 113, may be combined together on one semiconductor chip. For example, the processor 113, the memory device 115 and the network interface of the camera 103 may be implemented within a SOC. Furthermore, when implemented in this way, a general purpose processor and one or more of a GPU or VPU, and a DSP may be implemented together within the SOC.

In various example embodiments, the memory device 115 coupled to the processor 113 is operable to store data and computer program instructions. The memory device 115 may be implemented as Read-Only Memory (ROM), Programmable Read-Only Memory (PROM), Erasable Programmable Read-Only Memory (EPROM), Electrically Erasable Programmable Read-Only Memory (EEPROM), flash memory, one or more flash drives, universal serial bus (USB) connected memory units, magnetic storage, optical storage, magneto-optical storage, etc. or any combination thereof, for example. The memory device 115 may be operable to store memory as volatile memory, non-volatile memory, dynamic memory, etc. or any combination thereof.

Continuing with FIG. 1, the camera 103 is coupled to the server system 108. In some examples, the camera 103 is coupled to the server system 108 via one or more suitable networks. These networks can include the Internet, or one or more other public/private networks coupled together by network switches or other communication elements. The network(s) could be of the form of, for example, client-server networks, peer-to-peer networks, etc. Data connections between the camera 103 and the server system 108 can be any number of known arrangements, examples of which were previously herein detailed.

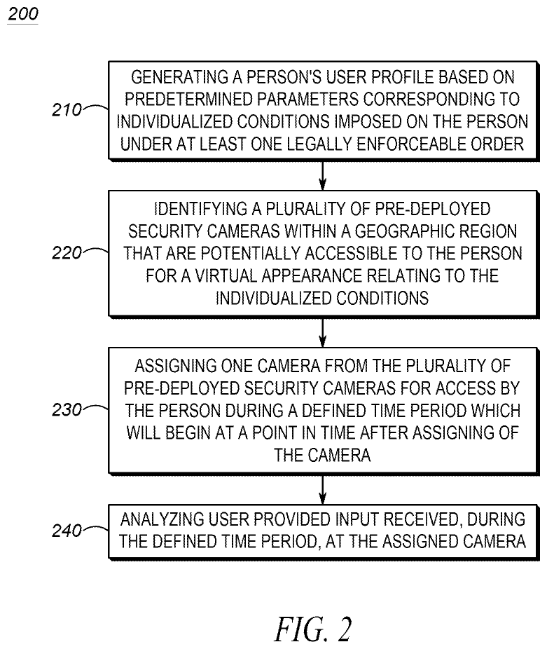

Reference is made to FIG. 2. FIG. 2 is a flow chart illustrating a method 200 in accordance with an example embodiment. Firstly in the method 200, a user profile for a person is generated (210) by operation of, for example, one or more processors within the multisite system 100. The user profile (which in some examples may be a parolee or probationer profile) is based on predetermined parameters corresponding to individualized conditions imposed on the person under at least one legally enforceable order. Regarding the at least one legally enforceable order, this may be, for example, a court order (such as, for instance, a court endorsed order that is directed at least in part to restricting movement of the person); however, other types of legally enforceable orders are contemplated as well.

Regarding the aforementioned individualized conditions, which are conditions under the at least one legally enforceable order, this may include, for example, at least one mobility restriction condition. Other types of individualized conditions such as, for instance, not becoming intoxicated, not using/possessing illicit drugs, etcetera, are contemplated as well.

Various examples of possible imposed mobility restriction conditions are contemplated. For instance, it may be required that the person subject to the order stay within one or more identified neighborhoods; it may be required that the person stay away from schools; it may be required that the person stay away from child playgrounds; it may be required that the person stay away from one or more other people identified in the at least one legally enforceable order; and it may be required that the person stay away from certain types of commercial establishments identified in the at least one legally enforceable order. Other examples of possible mobility restriction conditions are also contemplated.

Next in the method 200, and by operation of, for example, one or more processors within the multisite system 100, a plurality of pre-deployed security cameras within a geographic region are identified (220). These pre-deployed security cameras are potentially accessible to the person that will make a virtual appearance relating to the individualized conditions.

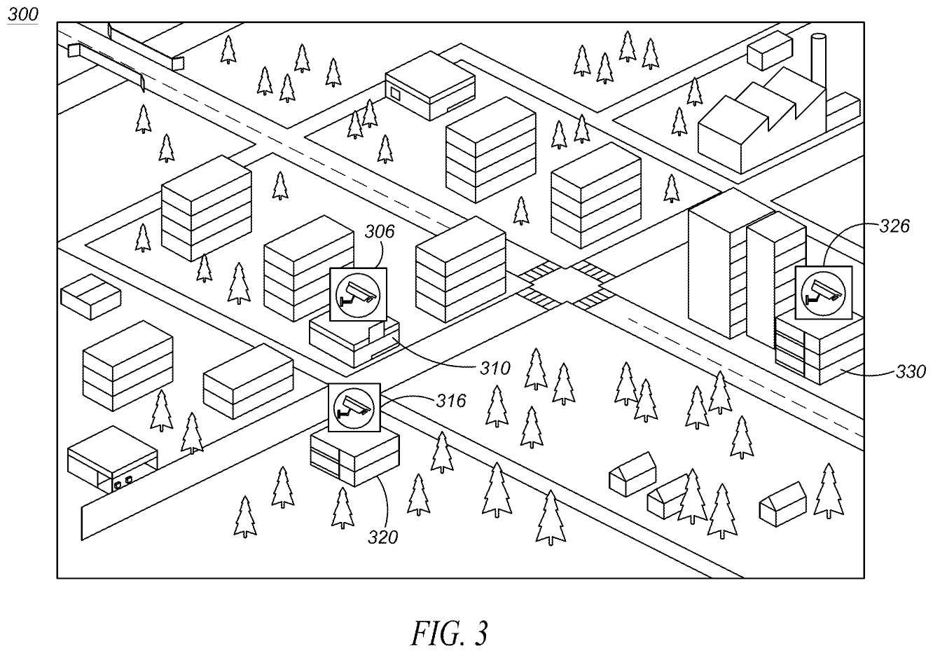

Regarding the above-mentioned camera identification, FIG. 3 is a diagram illustrating an example geographic region 300 (which may correspond to, for instance, a graphical user interface/interactive map generated on the display screen 126). In the geographic region 300, a security camera symbol 306 is shown superimposed on police station 310. Also in the geographic region 300, a security camera symbol 316 is shown superimposed on a public recreation building 320. Also in the geographic region 300, a security camera symbol 326 is shown superimposed on a government office building 330.

Next in the method 200, one camera from the plurality of pre-deployed security cameras is assigned (230) for access by the person making a virtual appearance during a defined time period. The action 230 may be effected by, for example, operation of one or more processors within the multisite system 100, and the defined time period may begin at a point in time after the assigning of the camera. In some examples, the defined time period may match a date amongst a plurality of dates on an appearance schedule imposed under the at least one legally enforceable order. In at least one of such examples, an at least one processor may be employed to dynamically update the appearance schedule to resolve a conflict introduced by a change in an employment schedule of the person.

Also regarding the action 230, in some examples assignable cameras amongst the plurality of pre-deployed security cameras are dynamically varied to limit, over a predetermined timeframe, a number of same camera assignments for virtual appearances on the appearance schedule.

In some examples, the assigned camera is equipped with at least one microphone and at least one speaker (for instance, the microphone 110 and the speaker 111) employable in combination for the person to engage in bidirectional audio interactions during the virtual appearance. These bidirectional audio interactions may include one or more verbal inquiries emitted via the at least one speaker. In at least one of such examples, the one or more verbal inquiries may be part of a live stream session with, for instance, a parole officer or a probation officer. Alternatively, the one or more verbal inquiries may be pre-recorded, and user-responses to the verbal inquiries may be received at the at least one microphone to form a recorded part of the user provided input.

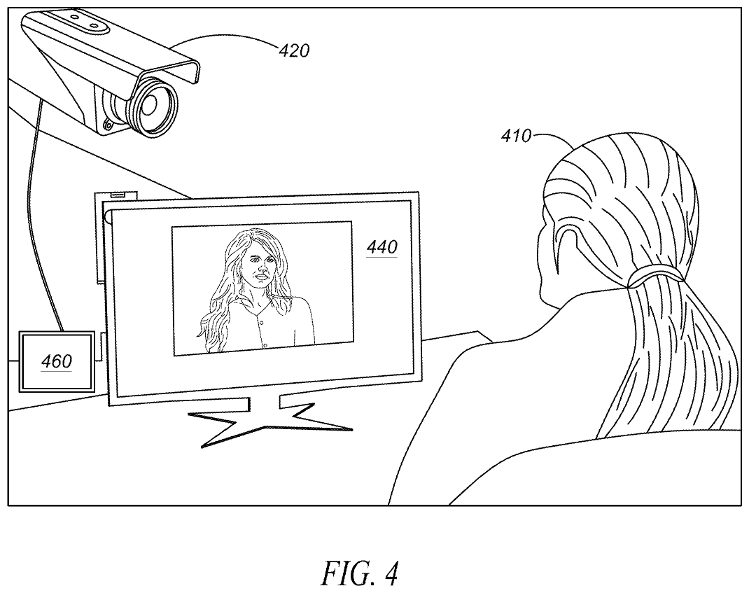

FIG. 4 is a diagram illustrating a virtual appearance consistent with the example embodiment of FIG. 2. In FIG. 4, person 410 positions himself in front of security camera 420 which may be, for instance, one of the camera devices 103₁-103_{N}. An optional display screen 440 is also shown, so that the person 410 can see another person asking him questions (in the case of a a live stream session.

Next in the method 200 of FIG. 2, received user provided input is analyzed (240). In some examples, the received user provided input to the assigned camera may include one or more of the following:
a trigger from a user-issued Radio Frequency (RF) tag or Near Field Communication (NFC) tag for gaining access to the assigned camera (in the illustrated example of FIG. 4, reader 460 is provided for wirelessly communicating with such an RF or NFC tag, or alternatively facial recognition or some other biometric-based recognition is contemplated as well, or alternatively some combination of any of these is also contemplated);
first activity by the person in video captured by the assigned camera that evidences presence of the person during the defined time period; and
second activity by the person in the video captured by the assigned camera that corresponds to the predetermined parameters.

In some examples, verification may be carried out (for instance, verification relating at least in part to analysis of the second activity) and, more specifically, verifying whether or not analytical results of the action 240 are indicative of compliance with the individualized conditions. The action 240 may includes video analytics and/or audio analytics effected by operation of one or more of the video analytics module 119, the video analytics engine 194 and/or audio analytics module(s). Contemplated examples of behaviors and/or attributes to be recognized by the modules include: bloodshot eyes (potential indication of alcohol/drug use); unusual mannerisms such as, for instance, lack of direct eye contact with camera (potential indication of trying to hide information); blurred speech (potential indication of alcohol/drug use); and unusual postures (potential indication of concealing an injury). As will be appreciated by those skilled in the art, learning machines such as, for example, convolutional networks can be trained and implemented, by conventional efforts (and without inventive experimentation), to recognize the behaviors and/or attributes that are herein contemplated.

In at least one example consistent with what is described above, a status update may be generated corresponding to the verifying of the analytical results. When the verifying of the analytical results indicates non-compliance with the individualized conditions, an alert may be communication to, for instance, a communications device of appropriate individual(s) (such as, for example, a parole officer or a probation officer).

The action 240 is carried out during the defined time period and at the assigned camera. (The person is providing the user provided input as an at least one verification of compliance condition imposed under the at least one legally enforceable order.)

As should be apparent from this detailed description above, the operations and functions of the electronic computing device are sufficiently complex as to require their implementation on a computer system, and cannot be performed, as a practical matter, in the human mind. Electronic computing devices such as set forth herein are understood as requiring and providing speed and accuracy and complexity management that are not obtainable by human mental steps, in addition to the inherently digital nature of such operations (e.g., a human mind cannot interface directly with RAM or other digital storage, cannot transmit or receive electronic messages, electronically encoded video, electronically encoded audio, etc., and cannot carry out computerized analytics of video/audio, among other features and functions set forth herein).

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. Unless the context of their usage unambiguously indicates otherwise, the articles “a,” “an,” and “the” should not be interpreted as meaning “one” or “only one.” Rather these articles should be interpreted as meaning “at least one” or “one or more.” Likewise, when the terms “the” or “said” are used to refer to a noun previously introduced by the indefinite article “a” or “an,” “the” and “said” mean “at least one” or “one or more” unless the usage unambiguously indicates otherwise.

Also, it should be understood that the illustrated components, unless explicitly described to the contrary, may be combined or divided into separate software, firmware, and/or hardware. For example, instead of being located within and performed by a single electronic processor, logic and processing described herein may be distributed among multiple electronic processors. Similarly, one or more memory modules and communication channels or networks may be used even if embodiments described or illustrated herein have a single such device or element. Also, regardless of how they are combined or divided, hardware and software components may be located on the same computing device or may be distributed among multiple different devices. Accordingly, in this description and in the claims, if an apparatus, method, or system is claimed, for example, as including a controller, control unit, electronic processor, computing device, logic element, module, memory module, communication channel or network, or other element configured in a certain manner, for example, to perform multiple functions, the claim or claim element should be interpreted as meaning one or more of such elements where any one of the one or more elements is configured as claimed, for example, to make any one or more of the recited multiple functions, such that the one or more elements, as a set, perform the multiple functions collectively.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Any suitable computer-usable or computer readable medium may be utilized. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. In the context of this document, a computer-usable or computer-readable medium may be any medium that can contain, store, communicate, propagate, or transport the program for use by or in connection with the instruction execution system, apparatus, or device.

Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation. For example, computer program code for carrying out operations of various example embodiments may be written in an object oriented programming language such as Java, Smalltalk, C++, Python, or the like. However, the computer program code for carrying out operations of various example embodiments may also be written in conventional procedural programming languages, such as the “C” programming language or similar programming languages. The program code may execute entirely on a computer, partly on the computer, as a stand-alone software package, partly on the computer and partly on a remote computer or server or entirely on the remote computer or server. In the latter scenario, the remote computer or server may be connected to the computer through a local area network (LAN) or a wide area network (WAN), or the connection may be made to an external computer (for example, through the Internet using an Internet Service Provider).

The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “one of”, without a more limiting modifier such as “only one of”, and when applied herein to two or more subsequently defined options such as “one of A and B” should be construed to mean an existence of any one of the options in the list alone (e.g., A alone or B alone) or any combination of two or more of the options in the list (e.g., A and B together).

A device or structure that is “configured” in a certain way is configured in at least that way, but may also be configured in ways that are not listed.

The terms “coupled”, “coupling” or “connected” as used herein can have several different meanings depending on the context in which these terms are used. For example, the terms coupled, coupling, or connected can have a mechanical or electrical connotation. For example, as used herein, the terms coupled, coupling, or connected can indicate that two elements or devices are directly connected to one another or connected to one another through intermediate elements or devices via an electrical element, electrical signal or a mechanical element depending on the particular context.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A computer-implemented method comprising:
generating, using an at least one processor, a user profile for a person, the user profile being based on predetermined parameters corresponding to individualized conditions imposed on the person under at least one legally enforceable order;
identifying, using the at least one processor, a plurality of pre-deployed security cameras within a geographic region that are potentially accessible to the person for a virtual appearance relating to the individualized conditions;
assigning, using the at least one processor, one camera from the plurality of pre-deployed security cameras for access by the person during a defined time period which will begin at a point in time after the assigning of the camera; and
analyzing, using the at least one processor, user provided input received, during the defined time period, at the assigned camera,
wherein the person is providing the user provided input as an at least one verification of compliance condition imposed under the at least one legally enforceable order.

2. The computer-implemented method of claim 1 wherein the individualized conditions include at least one mobility restriction condition, and the at least one legally enforceable order is a court order directed at least in part to restricting movement of the person.

3. The computer-implemented method of claim 2 wherein the user profile is a parolee or probationer profile, and the restricting of the movement of the person includes at least one of: requiring the person to stay within one or more identified neighborhoods; requiring the person to stay away from schools; requiring the person to stay away from child playgrounds; requiring the person to stay away from one or more other people identified in the at least one legally enforceable order; and requiring the person to stay away from certain types of commercial establishments identified in the at least one legally enforceable order.

4. The computer-implemented method of claim 1 wherein the defined time period matches a date amongst a plurality of dates on an appearance schedule imposed under the at least one legally enforceable order.

5. The computer-implemented method of claim 4 further comprising employing the at least one processor to dynamically update the appearance schedule to resolve a conflict introduced by a change in an employment schedule of the person.

6. The computer-implemented method of claim 4 wherein assignable cameras amongst the plurality of pre-deployed security cameras are dynamically varied to limit, over a predetermined timeframe, a number of same camera assignments for a series of virtual appearances on the appearance schedule.

7. The computer-implemented method of claim 1 wherein the received user provided input to the assigned camera includes:
a trigger from a user-issued Radio Frequency (RF) tag for gaining access to the assigned camera;
first activity by the person in video captured by the assigned camera that evidences presence of the person during the defined time period; and
second activity by the person in the video captured by the assigned camera that corresponds to the predetermined parameters.

8. The computer-implemented method of claim 7 further comprising:
verifying whether analytical results of the analyzing, which relate at least in part to analysis of the second activity, are indicative of compliance with the individualized conditions; and
generating a status update corresponding to the verifying of the analytical results.

9. The computer-implemented method of claim 8 further comprising communicating an alert to a communications device of a parole or probation officer when the verifying of the analytical results indicates non-compliance with the individualized conditions.

10. The computer-implemented method of claim 1 wherein:
the assigned camera is equipped with at least one microphone and at least one speaker employable in combination for the person to engage in bidirectional audio interactions during the virtual appearance, and
the bidirectional audio interactions include one or more verbal inquiries emitted via the at least one speaker.

11. The computer-implemented method of claim 10 wherein the one or more verbal inquiries comprise part of a live stream session with a parole or probation officer.

12. The computer-implemented method of claim 10 wherein the one or more verbal inquiries are pre-recorded, and user-responses to the verbal inquiries are received at the at least one microphone to form a recorded part of the user provided input.

13. A system comprising:
at least one processor; and
at least one electronic storage medium in communication with the at least one processor, the at least one electronic storage medium storing program instructions that when executed by the at least one processor cause the at least one processor to perform:
generating a user profile for a person, the user profile being based on predetermined parameters corresponding to individualized conditions imposed on the person under at least one legally enforceable order;
identifying a plurality of pre-deployed security cameras within a geographic region that are potentially accessible to the person for a virtual appearance relating to the individualized conditions;
assigning one camera from the plurality of pre-deployed security cameras for access by the person during a defined time period which will begin at a point in time after the assigning of the camera; and
analyzing user provided input received, during the defined time period, at the assigned camera,
wherein the person is providing the user provided input as an at least one verification of compliance condition imposed under the at least one legally enforceable order.

14. The system of claim 13 wherein the individualized conditions include at least one mobility restriction condition, and the at least one legally enforceable order is a court order directed at least in part to restricting movement of the person.

15. The system of claim 14 wherein the user profile is a parolee or probationer profile, and the restricting of the movement of the person includes at least one of: requiring the person to stay within one or more identified neighborhoods; requiring the person to stay away from schools; requiring the person to stay away from child playgrounds; requiring the person to stay away from one or more other people identified in the at least one legally enforceable order; and requiring the person to stay away from certain types of commercial establishments identified in the at least one legally enforceable order.

16. The system of claim 13 wherein the defined time period matches a date amongst a plurality of dates on an appearance schedule imposed under the at least one legally enforceable order.

17. The system of claim 16 wherein assignable cameras amongst the plurality of pre-deployed security cameras are dynamically varied to limit, over a predetermined timeframe, a number of same camera assignments for a series of virtual appearances on the appearance schedule.

18. The system of claim 13 wherein the received user provided input to the assigned camera includes:
a trigger from a user-issued Radio Frequency (RF) tag for gaining access to the assigned camera;
first activity by the person in video captured by the assigned camera that evidences presence of the person during the defined time period; and
second activity by the person in the video captured by the assigned camera that corresponds to the predetermined parameters.

19. The system of claim 13 wherein:
the assigned camera is equipped with at least one microphone and at least one speaker employable in combination for the person to engage in bidirectional audio interactions during the virtual appearance, and
the bidirectional audio interactions include one or more verbal inquiries emitted via the at least one speaker.

20. The system of claim 19 wherein the one or more verbal inquiries comprise part of a live stream session with a parole or probation officer.
